(19) United States
(12) Patent Application Publication
(10) Pub. No.: US 2017/0086196 A1
(43) Pub. Date: Mar. 23, 2017

(54) ADDING INTELLIGENCE TO MANUAL NETWORK SEARCH

(71) Applicant: QUALCOMM Incorporated, San Diego, CA (US)

(72) Inventors: Bhaskaran Arumugam, Hyderabad (IN); Sai Lokesh Ladhagiri Krishnakumar, Hyderabad (IN); Santhana Palanisamy, Hyderabad (IN)

(21) Appl. No.: 14/861,075

(22) Filed: Sep. 22, 2015

(51) Int. Cl. H04W 72/04; H04W 24/08; H04W 72/08

(52) U.S. Cl. CPC H04W 72/0453; H04W 72/085; H04W 24/08

(57) ABSTRACT

In accordance with the present disclosure network searching may include collecting one or more System Information (SI) for a plurality of cells associated with a wireless network; storing the one or more SI in a memory unit; generating a serving network frequency channel list based on the one or more stored SI; performing a power scan for one or more supported radio bands for one or more cells within the wireless network; obtaining an available frequency channel list from the power scan; comparing the available frequency channel list with the serving network frequency channel list if a Full Service Flag (FSF) has been set; and removing one or more frequency channels from the serving network frequency channel list to generate a reduced list.

### TECHNICAL FIELD

The following relates generally to wireless communication, and more specifically to adding intelligence to manual network search in radio access networks (RANs).

### BACKGROUND

Various radio access network (RAN) technologies are widely deployed to provide various types of wireless communication content such as voice, video, packet data, messaging, broadcast, and so on. In certain radio access network (RAN) technologies broadcast messages have been designed to support and carry Absolute Radio Frequency Channel Numbers (ARFCNs). Examples of RAN technologies may include Global System for Mobile Communications (GSM), Enhanced Data rates for GSM Evolution (EDGE), GSM EDGE Radio Access Network (GERAN), etc. In some examples, ARFCNs designate carrier frequencies for the uplink and downlink. ARFCNs are used for cell searches, for example, in manual and/or automatic cell searches.

### SUMMARY

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

According to various aspects, a method for network searching, including collecting one or more System Information (SI) for a plurality of cells associated with a wireless network; storing the one or more SI in a memory unit; generating a serving network frequency channel list based on the one or more stored SI; performing a power scan for one or more supported radio bands for one or more cells within the wireless network; obtaining an available frequency channel list from the power scan; comparing the available frequency channel list with the serving network frequency channel list if a Full Service Flag (FSF) has been set; and removing one or more frequency channels from the serving network frequency channel list to generate a reduced list.

According to various aspects, a user equipment for network searching, including a communications interface for communicating with a wireless network; a processing circuit coupled to the communications interface for collecting one or more System Information (SI) for a plurality of cells associated with the wireless network; a memory unit coupled to the communications interface for storing the one or more SI; and a radio resource module coupled to the communications interface for performing the following: generating a serving network frequency channel list based on the one or more stored SI; performing a power scan for one or more supported radio bands for one or more cells within the wireless network; obtaining an available frequency channel list from the power scan; comparing the available frequency channel list with the serving network frequency channel list if a Full Service Flag (FSF) has been set; and removing one or more frequency channels from the serving network frequency channel list to generate a reduced list.

According to various aspects, an apparatus for network searching, including means for collecting one or more System Information (SI) for a plurality of cells associated with a wireless network; means for storing the one or more SI in a memory unit; means for generating a serving network frequency channel list based on the one or more stored SI; means for performing a power scan for one or more supported radio bands for one or more cells within the wireless network; means for obtaining an available frequency channel list from the power scan; means for comparing the available frequency channel list with the serving network frequency channel list if a Full Service Flag (FSF) has been set; and means for removing one or more frequency channels from the serving network frequency channel list to generate a reduced list.

According to various aspects, a computer-readable storage medium storing computer executable code, operable on a device including at least one processor; a memory unit for storing one or more System information (SI), the memory unit coupled to the at least one processor; and the computer executable code including: instructions for causing the at least one processor to collect the one or more System Information (SI) for a plurality of cells associated with a wireless network; instructions for causing the at least one processor to generate a serving network frequency channel list based on the one or more System Information (SI); instructions for causing the at least one processor to perform a power scan for one or more supported radio bands for one or more cells within the wireless network; instructions for causing the at least one processor to obtain an available frequency channel list from the power scan; instructions for causing the at least one processor to compare the available frequency channel list with the serving network frequency channel list if a Full Service Flag (FSF) has been set; and instructions for causing the at least one processor to remove one or more frequency channels from the serving network frequency channel list to generate a reduced list.

### DRAWINGS

FIG. 1 illustrates a manual wireless network selection process.

FIG. 2 illustrates a first exemplary improved manual wireless network selection process in accordance with various aspects of the present disclosure.

FIG. 3 illustrates a second exemplary improved manual wireless network selection process in accordance with various aspects of the present disclosure.

FIG. 4 illustrates an exemplary wireless network environment in accordance with various aspects of the present disclosure.

FIG. 5 illustrates an exemplary block diagram of a network architecture particular to a mixed RAN environment in accordance with various aspects of the present disclosure.

FIG. 6 illustrates an exemplary block diagram of selected components of an exemplary base station (BS) in accordance with various aspects of the present disclosure.

FIG. 7 illustrates an exemplary block diagram of selected components of an exemplary user equipment (UE) in accordance with various aspects of the present disclosure.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques, and components are shown in block diagram form to avoid obscuring the described concepts and features.

The word “exemplary” is used herein to mean “serving as an example, instance, or illustration.” Any example described herein as “exemplary” is not necessarily to be construed as preferred or advantageous over other disclosed examples.

As will be described below, methods and apparatus are disclosed that improve network search performance when a search is performed, for examples, when a manual search is performed. Wireless network search performance is generally quantified by the search time, that is, the time required to select a wireless network and a cell within the wireless network. The search time may be dominated by the quantity of frequency channels which are searched by a user equipment (UE) using a power scan. A power scan is a measurement of, for example, received signal strength indication (RSSI) at the UE of transmit or beacon signals from a base station. The power scan may be used to select a cell within a wireless network according to the received signal strength indication (RSSI), for example.

For example, in wireless networks, such as Global System for Mobility (GSM), an initialization process may be performed by a user equipment (UE) to commence communication services. For example, the initialization process may include selection of a wireless network and selection of a cell within the wireless network. Either or both the wireless network selection and the cell selection may be performed automatically or manually, for example, by a user.

The initialization process may first perform a wireless network selection, for example, a public land mobile network (PLMN) selection. Next, the initialization process may perform a cell selection, where a cell is part of the selected wireless network.

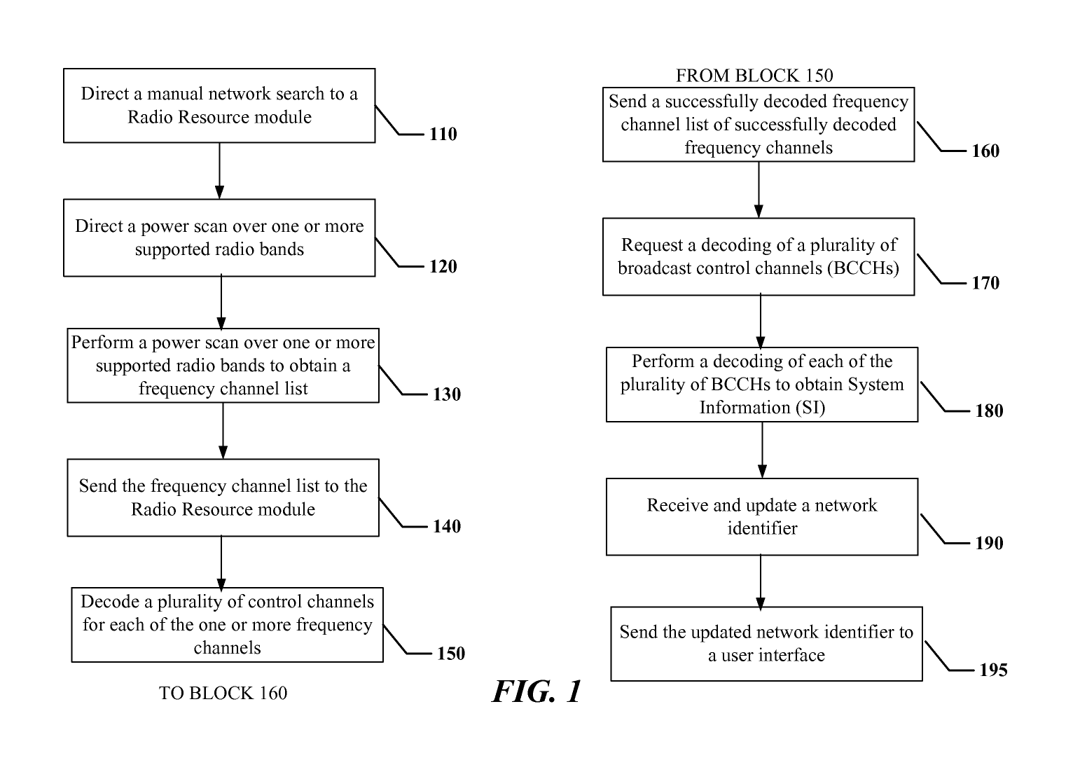

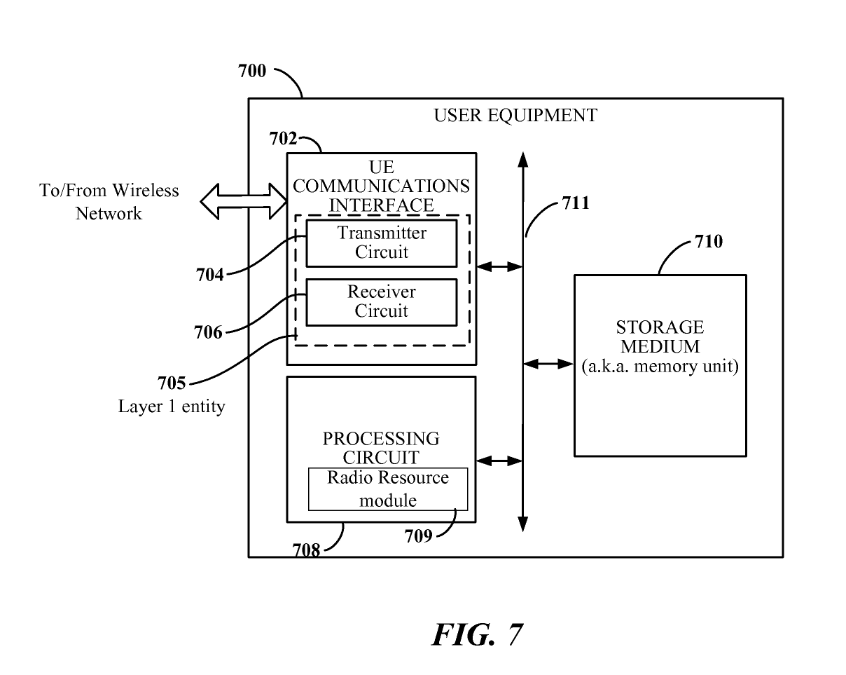

FIG. 1 illustrates a manual wireless network selection process 100. For example, in the manual network selection process, several steps may be performed by the UE, as illustrated in FIG. 1. In block 110, a processing circuit (e.g., processing circuit 708 in FIG. 7 or a processing circuit (not shown) embedded within the receiver circuit 706) directs a manual network search to a Radio Resource module. For example, the manual network search may be a manual PLMN search and the Radio Resource module may be a GERAN (GSM EDGE radio access network) Radio Resource (GRR) module.

In block 120, the Radio Resource module directs a Layer 1 entity to perform a power scan over one or more supported radio bands. For example, the Layer 1 entity may be a GSM EDGE Radio Access Network (GERAN) Layer 1 entity. In various examples, the Layer 1 entity is the receiver circuit 706 (shown in FIG. 7). In block 130, the Layer 1 entity performs a power scan over the one or more supported radio bands to obtain a frequency channel list of one or more frequency channels within the one or more supported radio bands. In various examples, a supported radio band is a radio band supported by the UE. And, when a radio band is supported by the UE, the UE is able to obtain a frequency channel list of one or more frequency channels within that radio band that may potentially be used by the UE.

In block 140, the Layer 1 entity sends the frequency channel list of the one or more frequency channels to the Radio Resource module. In various examples, the frequency channel list may organize the one or more frequency channels in an order of radio signal strength indication (RSSI). For example, a frequency channel with a greater RSSI is listed on top of the frequency channel list before another frequency channel with a lower RSSI.

In block 150, the Layer 1 entity decodes a plurality of control channels for each of the one or more frequency channels. For example, the plurality of control channels may be frequency correction channels (FCCHs) and/or synchronization channels (SCHs). For example, the one or more frequency channels may be indexed by an absolute radio frequency channel number (ARFCN). In various examples, the frequency channel list may list the one or more frequency channels in an order of ARFCN.

In block 160, the Layer 1 entity sends a successfully decoded frequency channel list of successfully decoded frequency channels to the Radio Resource module.

In block 170, the Radio Resource module requests the Layer 1 entity to perform a decoding of a plurality of broadcast control channels (BCCHs) based on the successfully decoded frequency channel list. In various examples, each BCCH may correspond to an ARFCN.

In block 180, the Layer 1 entity performs a decoding of each of the plurality of BCCHS to obtain System Information (SI) elements SI3 and SI4 for each of a plurality of cells within a wireless network. Each decoded BCCH may include System Information (SI) elements (i.e., decoded BCCH SI elements) which contain network identifiers. For example, SI3 and SI4 contain a network identifier and cell selection criteria.

In block 190, the Radio Resource module and/or a processing circuit (e.g., processing circuit 708 in FIG. 7 or a processing circuit (not shown) embedded within the receiver circuit 706 of FIG. 7) receives and updates a network identifier based on one or more decoded BCCH SI elements. In various examples, the network identifier may be a PLMN ID.

In block 195, the Radio Resource module sends the updated network identifier (e.g., a PLMN ID) to a user interface where it may be displayed to a user.

In various examples, a feature of the manual network selection process described in FIG. 1 is that the power scan results may yield a large quantity of frequency channels. For example, the quantity of frequency channels may be as high as 548. In addition, some of the frequency channels may belong to a serving network, for example, a serving PLMN. Consequently, a large number of control channels (e.g., FCCHs, SCHs, BCCHs) decoding steps may be required which may result in a long manual network search and high dc power consumption due to the numerous Layer 1 entity activities.

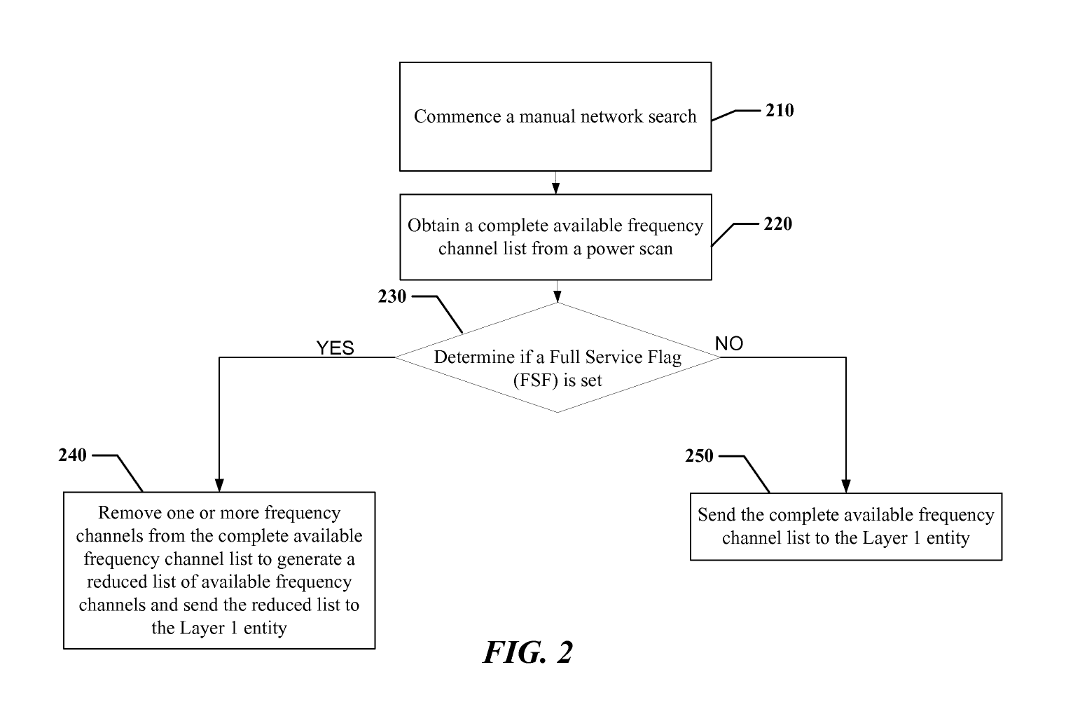

FIG. 2 illustrates a first exemplary improved manual wireless network selection process 200 in accordance with various aspects of the present disclosure. In block 210, a Radio Resource module in a UE commences a manual network search. In various examples, the manual network search may be a manual public land mobile network (MPLMN) search. In various examples, the manual network search commences once the Radio Resource module stores System Information (SI) obtained from a serving network ARFCN list. In various examples, the serving network ARFCN list is created by the Radio Resource module. In various examples, the serving network ARFCN list is a list of Absolute Radio Frequency Channel Numbers (ARFCNs) for the serving network. And, in various examples, the serving network is a network providing wireless communication services to a UE. In various examples, the manual network search commences after a Non Access Stratum (NAS) entity sets a Full Service Flag (FSF). A FSF is set if the UE is camped with Full Service in a PLMN (i.e., a serving network PLMN). In various examples, the Non Access Stratum (NAS) entity is a component within the UE which performs one or more functions not related to wireless access.

In block 220, the Radio Resource module obtains a complete available frequency channel list from a power scan. For example, the power scan may be performed by a Layer 1 entity. A complete available frequency channel list is a list of all frequency channels that are available to the UE for wireless communication access.

In block 230, the Radio Resource module determines if a Full Service Flag (FSF) is set. If the FSF is set, then proceed to block 240. If the FSF is not set, then proceed to block 250.

In block 240, the Radio Resource module removes one or more frequency channels from the complete available frequency channel list to generate a reduced list of available frequency channels and sends the reduced list to the Layer 1 entity. In various examples, the reduced list is sent to the Layer 1 entity prior to the Layer 1 entity performing control channel decoding. In various examples, the control channel decoding may include FCCH decoding and SCH decoding.

In block 250, the Radio Resource module sends the complete available frequency channel list to the Layer 1 entity. In various examples, the complete available frequency channel list is sent to the Layer 1 entity prior to the Layer 1 entity performing control channel decoding. In various examples, the control channel decoding may include FCCH decoding and SCH decoding.

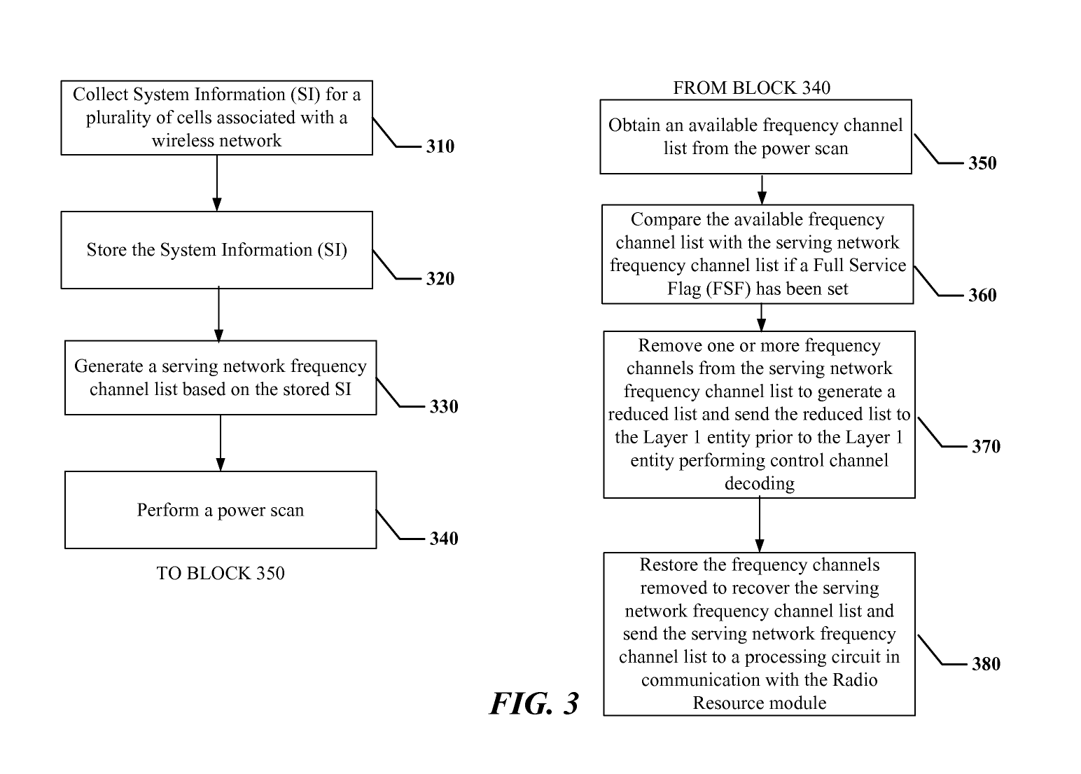

FIG. 3 illustrates a second exemplary improved manual wireless network selection process 300 in accordance with various aspects of the present disclosure. In block 310, a processing circuit (e.g., processing circuit 708 in FIG. 7) within a UE collects System Information (SI) for a plurality of cells associated with a wireless network, wherein the UE is in wireless communication with a cell within the wireless network. In various examples, the System Information (SI) may include cell channels, neighbor cell information, control channel information, cell ID, location area information, cell selection parameters, etc. In some examples, a Radio Resource module (e.g., Radio Resource module 709 shown in FIG. 7) may collect the System Information (SI).

In block 320, a memory unit stores the System Information (SI). In some examples, the Radio Resource module may store the System Information (SI) in the memory unit. In various examples, the memory unit is a storage medium 710 of FIG. 7. For example, the stored SI means that the serving network frequency channel list is based on a priori information (e.g., information that was obtained prior to a power scan).

In block 330, the Radio Resource module generates a serving network frequency channel list based on the stored SI. In various examples, the serving network frequency channel list is generated by also using one or more System Information from a cell currently serving the UE (i.e., a currently serving cell) wherein the cell is part of the serving network. In various examples, the serving network frequency channel list may include one or more Absolute Radio Frequency Channel Numbers (ARFCNs). In various examples, the serving network frequency channel list is a list of frequency channels for the serving network, and the serving network is a network providing wireless communication services to a UE. In various examples, the serving network frequency channel list is a serving network ARFCN list which is a list of Absolute Radio Frequency Channel Numbers (ARFCNs) for the serving network. For example, the serving network frequency channel list may be generated by storing SIs (e.g., SI2) of various cells from the serving network (e.g., serving PLMN).

In block 340, a Layer 1 entity (e.g., Layer 1 entity 705 shown in FIG. 7) performs a power scan. In various examples, the power scan is performed for one or more supported radio bands and for one or more cells within a wireless network. In some examples, the Layer 1 entity is a GSM EDGE Radio Access Network (GERAN) Layer 1 entity.

In block 350, the Radio Resource module obtains an available frequency channel list from the power scan. In various examples, the available frequency channel list is a list of frequency channels associated with the wireless network that is deemed available for use by a UE based on the power scan. In various examples, the available frequency channel list may include one or more available ARFCNs. In various examples, the power scan includes performing a comparison between a received signal strength indication (RSSI) and a RSSI threshold. If the RSSI is equal to or exceeds the RSSI threshold for a particular frequency channel, then that frequency channel is deemed an available frequency channel and is included in the available frequency channel list. If the RSSI is below the RSSI threshold for a particular frequency channel, then that frequency channel is deemed not an available frequency channel and is not included in the available frequency channel list.

In block 360, the Radio Resource module compares the available frequency channel list with the serving network frequency channel list if a Full Service Flag (FSF) has been set. For example, the FSF may be set by a processing circuit in communication with the Radio Resource module. In various examples, the processing circuit may be part of a Non Access Stratum (NAS) entity. The processing circuit may determine if the wireless network is a home network. For example, the home network may be a home PLMN (HPLMN). If the determination is that the wireless network is in the home network, the FSF may be set. For example, the FSF may be a SERVICE_ON_HPLMN flag. In various examples, Full Service means both voice and data services are available on the serving network (e.g., the wireless network).

In block 370, the Radio Resource module removes one or more frequency channels from the serving network frequency channel list to generate a reduced list and sends the reduced list to the Layer 1 entity prior to the Layer 1 entity performing control channel decoding. The Layer 1 entity may perform control channel decoding for each of the frequency channels in the reduced list. In various examples, the control channel decoding may include FCCH decoding and SCH decoding.

In block 380, the Radio Resource module restores the frequency channels removed to recover the serving network frequency channel list and sends the serving network frequency channel list to a processing circuit in communication with the Radio Resource module. In various examples, the processing circuit is processing circuit 708 shown in FIG. 7. The steps described in the blocks in FIG. 3 may provide a faster manual network search (i.e., reduced search time) and may require lower dc power consumption by the UE. And, in various examples, the steps described in the blocks in FIG. 3 may provide improved performance in idle mode (e.g., when the UE has multiple SIM capability).

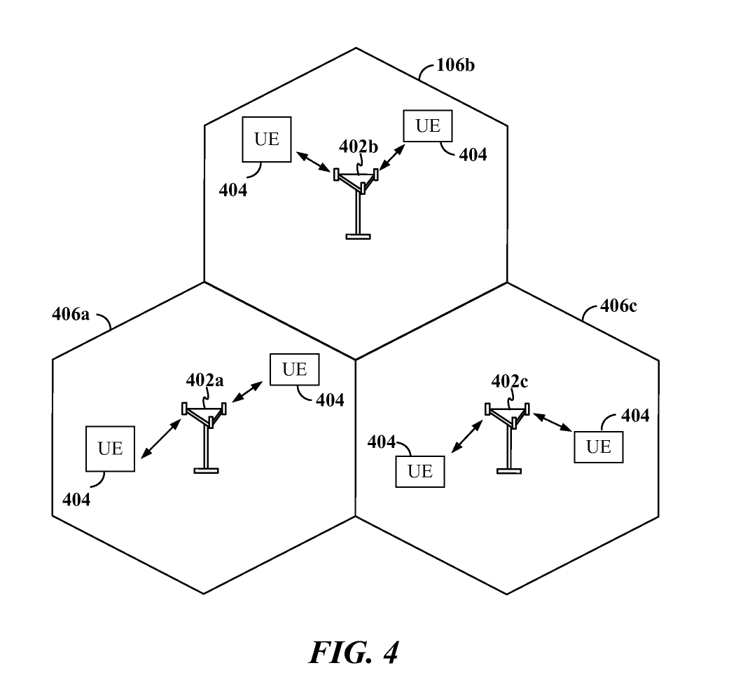

For the purpose of contextualization, FIG. 4 illustrates an exemplary wireless network environment 400 in accordance with various aspects of the present disclosure. The wireless network environment 400 is a multi-cell (e.g., base stations 402a, 402b, 402c) as well as multi-RAN environment where multiple RAN technologies may be present and one or more User Equipment (UE) 404 (which may also be referred to as access terminal or Mobile Stations (MS)) have mobility across the various RANs. In one example, the RAN technologies may be a GSM Edge Radio Access Network (GERAN). In various examples, a single base station may be referred to as base station 402.

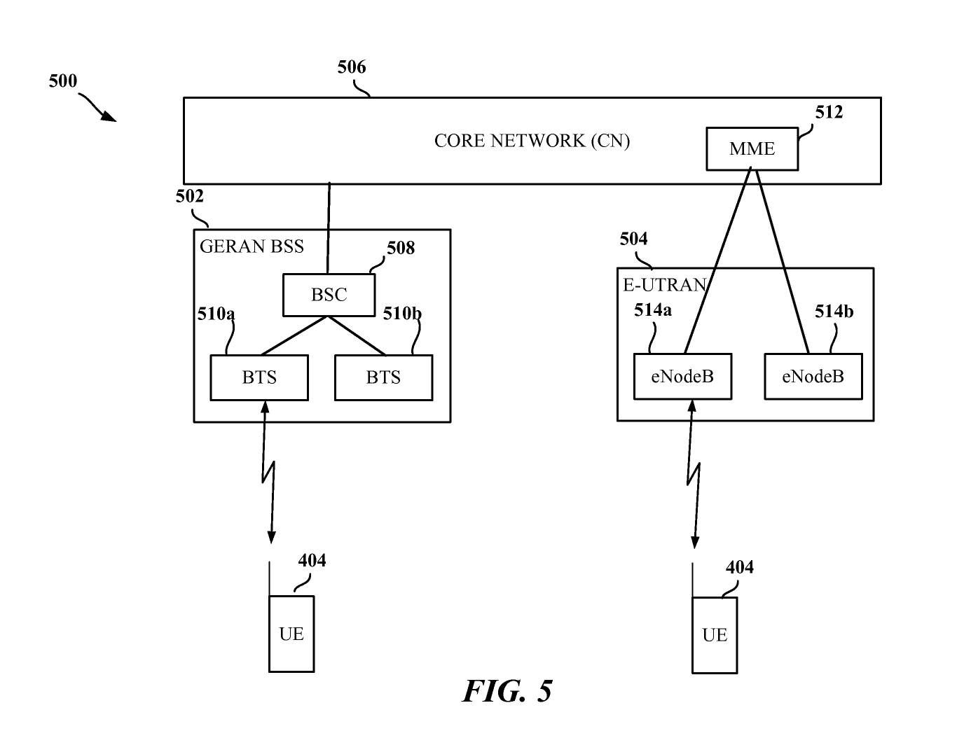

Base station 402 may also be referred to as, and may include some or all of the functionality of various transceiver devices across various technologies including devices termed NodeB, evolved NodeB (eNodeB or eNB), access point, base transceiver station (BTS), broadcast transmitter, etc. Each base station 402 provides communication coverage for a particular geographic area. A base station 402 may provide communication coverage for one or more UEs 404. The term “cell” may refer to a base station 402 and/or its coverage area depending on the context in which the term is used. The base stations 402 can wirelessly communicate with the UE 404 via a base station antenna. The base stations 402 may each be implemented generally as a device adapted to facilitate wireless connectivity (for one or more UEs 404) to the wireless network environment 400. The base stations 402 are configured to communicate with the UE 404 under the control of base station control (see FIG. 5) via multiple carriers. Each base station 402 can provide radio access communication coverage for a respective geographic area. The coverage area 406 for each base station 402 (i.e., base stations 402a, 402b, 402c, respectively) may be identified as 406a, 406b, and 406c, for example. The coverage area 406 for a base station 402 may be divided into sectors (not shown), which make up only a portion of the coverage area. The wireless network environment 400 may include base stations 402 of different types (e.g., macro, micro, femto, and/or pico base stations).

One or more UEs 404 may be extant within the coverage areas 406. Each UE 404 may communicate with one or more base stations 402. An UE 404 may generally include one or more devices that communicate with one or more other devices through wireless signals. Although the GSM designation MS is used in this description, it will be appreciated that other known nomenclatures describing mobile wireless devices such as access terminal, user equipment (UE), subscriber station, mobile unit, subscriber unit, wireless unit, remote unit, mobile device, wireless device, wireless communications device, remote device, mobile subscriber station, mobile terminal, wireless terminal, remote terminal, handset, terminal, mobile client, client, or some other suitable terminology may be applicable.

Although the terminology MS and UE is used predominantly in this disclosure, other terms suitable for describing UE 404 could include a mobile phone, smart phone, wireless modem, personal media player, laptop computer, tablet computer, network enabled television, appliance, e-reader, digital video recorder (DVR), a machine-to-machine (M2M) device, and/or other communication/computing device which communicates, at least partially, via a radio access network.

The wireless communication system 400 may be a multiple-access system capable of supporting communication with multiple UEs 404 by sharing the available system resources (e.g., bandwidth and transmit power). Examples of such multiple-access systems include code division multiple access (CDMA) systems, wideband code division multiple access (W-CDMA) systems, time division multiple access (TDMA) systems, frequency division multiple access (FDMA) systems, orthogonal frequency division multiple access (OFDMA) systems, single-carrier frequency division multiple access (SC-FDMA) systems, 3rd Generation Partnership Project (3GPP) GERAN and Long Term Evolution (LTE) systems and spatial division multiple access (SDMA) systems.

FIG. 5 illustrates an exemplary block diagram of a network architecture 500 particular to a mixed RAN environment in accordance with various aspects of the present disclosure, for example, utilizing GSM (e.g., GERAN) and LTE (e.g., E-UTRAN) radio access networks. As illustrated, the network architecture 500 may include a base station subsystem (BSS) 502. In various examples, the BSS 502 implements a GERAN network and may be referred to as a GERAN BSS 502. Also as illustrated, the network architecture 500 may include an E-UTRAN network 504. In various examples, the GERAN BSS 502 and/or the E-UTRAN network 504 may implement a radio access network (RAN).

The GERAN BSS 502 and the E-UTRAN network 504 are generally adapted to manage traffic and signaling between one or more UEs 404 and one or more other network entities, such as via a core network (CN) 506. As illustrated, each of the GERAN BSS 502 and the E-UTRAN network 504 may be tied to the core network (CN) 506 providing various services to UE 404 that are connected via the GERAN BSS 502 and the E-UTRAN network 504. The core network (CN) 506 may include a circuit-switched (CS) domain and a packet-switched (PS) domain. In general, a UE 404 can obtain access to a public switched telephone network (PSTN) (not shown) via the circuit-switched domain, and to an IP network (not shown) via the packet-switched domain.

Included within the GERAN BSS 502 are various numbers of base station controllers (BSC), shown in FIG. 5 with only one exemplary BSC 508 for simplicity. Each BSC 508 may control one or more base transceiver stations (BTS) 510a, 510b. Each BTS 510a, 510b communicates with various UEs 404 via radio uplink and downlink. Similar, the E-UTRAN network 504 includes a number of eNodeBs, with two eNodeBs 514a and 514b shown for example in the E-UTRAN network 504. In evolved networks such as E-UTRAN, eNodeBs (i.e., base stations for LTE) may be connected with one or more Mobility Management Entities (i.e., MMEs and shown singularly as MME 512 for simplicity of illustration) in the core network (CN) 506. Additionally, in various examples, one or more gateways may be used in the evolved networks (not shown). MME 512 may handle, among other things, signalling related to mobility and security for E-UTRAN access. Each of the eNodeBs 514a, 514b communicates with various UEs 404 via the radio uplink and downlink.

In addition to one or more base stations 402, the GERAN BSS 502 may include a base station controller (BSC) 508, which may also be referred to by those of skill in the art as a radio network controller (RNC). The base station controller (BSC) 508 is generally responsible for the establishment, release, and maintenance of wireless connections within one or more coverage areas associated with the one or more base stations 402 which are connected to the base station controller (BSC) 508. The base station controller (BSC) 508 may be communicatively coupled to one or more nodes or entities of the core network (CN) 506.

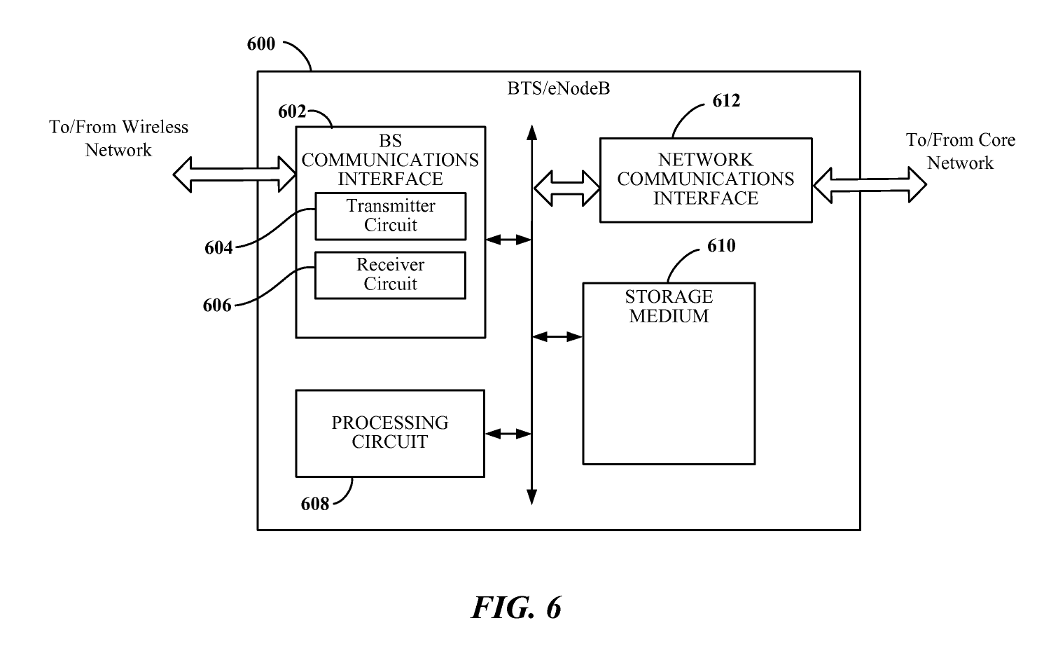

FIG. 6 illustrates an exemplary block diagram of selected components of an exemplary base station (BS) 600 (e.g., BTS, or eNodeB) in accordance with various aspects of the present disclosure. Although indicated as a base station, one skilled in the art will appreciate that the functional components shown in FIG. 6 and their associated functions could also be effected by other devices within a base station subsystem (See e.g., subsystem 502 in FIG. 5), or shared between components in a BSS.

As illustrated, FIG. 6 shows that the base station (BS) 600 includes a BS communications interface 602 configured for radio link communication in the wireless network; namely radio communication with UEs 404. The BS communications interface 602 includes one or more transmitter circuits 604 and one or more receiver circuits 606. The BS communications interface 602 is communicatively coupled with other components in base station (BS) 600, including processing circuitry 608, storage medium 610, and a network communications interface 612.

The BS communications interface 602 is configured to facilitate wireless communications of the base station (BS) 600. For example, the BS communications interface 602 may include circuitry and/or programming adapted to facilitate the communication of information bi-directionally with respect to one or more UEs 404. The BS communications interface 602 may be communicatively coupled to one or more antennas (not shown). Additionally, the transmitter circuitry 604 and the receiver circuitry 606 may include, by way of example and not limitation, devices and/or programming associated with a data path (e.g., antenna, amplifiers, filters, mixers) and with a frequency path (e.g., a phase-locked loop (PLL) component).

The processing circuitry 608 is arranged to obtain, process and/or send data, control data access and storage, issue commands and messages, and control other desired operations. The processing circuit 608 may include circuitry adapted to implement desired programming provided by appropriate storage media in at least one example. For example, the processing circuit 608 may be implemented as one or more processors, one or more controllers, and/or other structure configured to execute executable programming. Examples of the processing circuit 608 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 608 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 608 are for illustration and other suitable configurations within the scope of the present disclosure are also contemplated.

The processing circuitry 608 is specifically configured to execute programming, which may be stored on the storage medium 610. As used herein, the term “programming” shall be construed broadly to include without limitation instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Storage medium 610 may represent one or more computer-readable, machine-readable, and/or processor-readable devices for storing programming, such as processor executable code or instructions (e.g., software, firmware), electronic data, databases, or other digital information. Storage medium 610 may also be used for storing data that is manipulated by the processing circuitry 608 when executing programming. The storage medium 610 may be any available media that can be accessed by a general purpose or special purpose processor, including portable or fixed storage devices, optical storage devices, and various other mediums capable of storing, containing and/or carrying programming. By way of example and not limitation, the storage medium 610 may include a computer-readable, machine-readable, and/or processor-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof. The storage medium 610 may be communicatively coupled to the processing circuit 608 such that the processing circuit 608 may read information from, and write information to, the storage medium 610.

The network communications interface 612 (shown in FIG. 6) is configured to communicate with other network devices in the RAN or BSS, or the MME (in the case of eNodeB), or the CN. The network communications interface 612 may be configured to operate under any suitable communication protocol utilized in the various RAN standards.

FIG. 7 illustrates an exemplary block diagram of selected components of an exemplary user equipment (UE) 700 in accordance with various aspects of the present disclosure. The UE 700 is illustrated showing select components which may include a UE communications interface 702 for wireless communication with one or more RANs (e.g., one or more wireless network). The UE communications interface 702 includes a transmitter circuit 704 and a receiver circuit 706. In addition, the UE communications interface 702 includes a Layer 1 entity 705 which performs certain physical layer functions, such as receive power measurements, frequency control, timing control, power control, etc. For simplicity the UE communications interface 702 is shown singular, but one skilled in the art will realize that the UE communications interface 702 may consist of multiple radio circuits each configured to communicate with respective RAN technologies.

The UE 700 also includes a processing circuit 708 communicatively coupled with the UE communications interface 702 and storage medium 710. In various examples, the transmitter circuit 704 and/or the receiver circuit 706 may be implemented as one or more processors, one or more controllers, and/or other structure configured to execute executable programming. Storage medium 710 may be engendered as one or more computer-readable, machine-readable, and/or processor-readable devices for storing programming, such as processor executable code or instructions (e.g., software, firmware), electronic data, databases, or other digital information.

The processing circuit 708 is arranged to obtain, process and/or send data, control data access and storage, issue commands, and control other desired operations. In various examples, the processing circuit 708 may be implemented as one or more processors, one or more controllers, and/or other structure configured to execute executable programming, including, but not limited to, a general purpose processor, a Digital Signal Processor (DSP), an Application Specific Integrated Circuit (ASIC), a Field Programmable Gate Array (FPGA), or any other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 708 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 708 are for illustration and other suitable configurations within the scope of the present disclosure are also contemplated.

The processing circuit 708 is adapted for processing, including the execution of programming, which may be stored on the storage medium 710. As used herein, the term “programming” shall be construed broadly to include without limitation instructions, instruction sets, data, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The UE communications interface 702 is configured to facilitate wireless communications of the UE 700. For example, the UE communications interface 702 may include circuitry and/or programming adapted to facilitate the communication of information bi-directionally with respect to one or more network nodes. The UE communications interface 702 may be coupled to one or more antennas (not shown), and includes wireless transceiver circuitry, including at least one receiver circuitry 706 (e.g., one or more receiver chains) and/or at least one transmitter circuitry 704 (e.g., one or more transmitter chains). By way of example and not limitation, the at least one receiver circuitry 706 may include circuitry, devices and/or programming associated with a data path (e.g., antenna, amplifiers, filters, mixers) and with a frequency path (e.g., a PLL component).

The storage medium 710 may represent one or more computer-readable, machine-readable, and/or processor-readable devices for storing programming, such as processor executable code or instructions (e.g., software, firmware), electronic data, databases, or other digital information. The storage medium 710 may also be used for storing data that is manipulated by the processing circuit 708 when executing programming. The storage medium 710 may be any available medium that can be accessed by a general purpose or special purpose processor, including portable or fixed storage devices, optical storage devices, and various other mediums capable of storing, containing and/or carrying programming. By way of example and not limitation, the storage medium 710 may include a computer-readable, machine-readable, and/or processor-readable storage medium such as a magnetic storage device (e.g., hard disk, floppy disk, magnetic strip), an optical storage medium (e.g., CD, DVD), a smart card, a flash memory device (e.g., card, stick, key drive), RAM, ROM, PROM, EPROM, electrically erasable EEPROM, a register, a removable disk, and/or other mediums for storing programming, as well as any combination thereof. In various examples, a Radio Resource module 709 may be part of (i.e., housed within) the processing circuit 708 and executes executable codes stored in the storage medium 710.

The storage medium 710 may be communicatively coupled to the processing circuit 708 such that the processing circuit 708 may read information from, and write information to, the storage medium 710. That is, the storage medium 710 can be coupled to the processing circuit 708 so that the storage medium 710 is at least accessible by the processing circuit 708, including examples where the storage medium 710 is integral to the processing circuit 708 and/or examples where the storage medium 710 is separate from the processing circuit 708 (e.g., resident in the UE 700, external to the UE 700, and/or distributed across multiple entities).

Programming stored by the storage medium 710, when executed by the processing circuit 708, causes the processing circuit 708 to perform one or more of the various functions and/or process steps described herein. Thus, according to one or more aspects of the present disclosure, the processing circuit 708 is adapted to perform (in conjunction with the storage medium 710) any or all of the processes, functions, steps and/or routines for any or all of the UEs 404 described herein. As used herein, the term “adapted” in relation to the processing circuit 708 may refer to the processing circuit 708 being one or more of configured, employed, implemented, and/or programmed (in conjunction with the storage medium 710) to perform a particular process, function, step and/or routine according to various features described herein. In various examples, the user equipment includes a bus interface 711 for coupling the communications interface 702, the processing circuit 708 and the storage medium 710.

It is also noted that the various concepts presented throughout this disclosure may be implemented across a broad variety of telecommunication systems, network architectures, and communication standards. Certain aspects of the discussions are described herein in relation to Global System for Mobile Communications (GSM), and in relation to 3^{rd} Generation Partnership Project (3GPP) protocols and systems, and related terminology may be found in much of the foregoing description. However, those of ordinary skill in the art will recognize that one or more aspects of the present disclosure could be adapted to be employed and included in one or more other wireless communication protocols and systems.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associated with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow. The techniques described herein may be used for various communication systems, including communication systems that are based on an orthogonal multiplexing scheme.

The terms “memory” or “storage medium” may encompass any electronic component capable of storing electronic information. In particular, these terms may connote various types of processor-readable media such as random access memory (RAM), read-only memory (ROM), non-volatile random access memory (NVRAM), programmable read-only memory (PROM), erasable programmable read only memory (EPROM), electrically erasable PROM (EEPROM), flash memory, magnetic or optical data storage, registers, etc. Memory is said to be in electronic communication with a processor if the processor can read information from and/or write information to the memory. Memory that is integral to a processor is in electronic communication with the processor.

Also, the terms “instructions” and “code” may include any type of computer-readable statement(s). For example, the terms “instructions” and “code” may refer to one or more programs, routines, sub-routines, functions, procedures, etc. “Instructions” and “code” may comprise a single computer-readable statement or many computer-readable statements.

The functions described herein may be implemented in software or firmware being executed by hardware. The functions may be stored as one or more instructions on a computer-readable medium. The terms “computer-readable medium” or “computer-program product” refers to any tangible storage medium that can be accessed by a computer or a processor. By way of example, and not limitation, a computer-readable medium may comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), floppy disk and Blu-ray® disc where disks usually reproduce data magnetically, while discs reproduce data optically with lasers. It should be noted that a computer-readable medium may be tangible and non-transitory. The term “computer-program product” refers to a computing device or processor in combination with code or instructions (e.g., a “program”) that may be executed, processed or computed by the computing device or processor. As used herein, the term “code” may refer to software, instructions, code or data that is/are executable by a computing device or processor.

Software or instructions may also be transmitted over a transmission medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of transmission medium.

The methods disclosed herein comprise one or more steps or actions for achieving the described method. The method steps and/or actions may be interchanged with one another without departing from the scope of the claims. In other words, unless a specific order of steps or actions is required for proper operation of the method that is being described, the order and/or use of specific steps and/or actions may be modified without departing from the scope of the claims.

Finally, it is to be understood that the claims are not limited to the precise configuration and components illustrated above. Various modifications, changes and variations may be made in the arrangement, operation, and details of the systems, methods, and apparatus described herein without departing from the scope of the claims.

What is claimed is:

1. A method for network searching, comprising:
collecting one or more System Information (SI) for a plurality of cells associated with a wireless network;
storing the one or more SI in a memory unit;
generating a serving network frequency channel list based on the one or more stored SI;
performing a power scan for one or more supported radio bands for one or more cells within the wireless network;
obtaining an available frequency channel list from the power scan;
comparing the available frequency channel list with the serving network frequency channel list if a Full Service Flag (FSF) has been set; and
removing one or more frequency channels from the serving network frequency channel list to generate a reduced list.

2. The method of claim 1, further comprising sending the reduced list to an entity prior to the entity performing a control channel decoding.

3. The method of claim 2, wherein the entity is a Layer 1 entity within a user equipment (UE).

4. The method of claim 1, further comprising restoring the one or more frequency channels removed to recover the serving network frequency channel list.

5. The method of claim 1, wherein the System Information (SI) includes one or more of the following: a cell channel, a neighbor cell information, a control channel information, a cell ID, a location area information, or a cell selection parameters.

6. The method of claim 1, wherein the serving network frequency channel list includes one or more Absolute Radio Frequency Channel Numbers (ARFCNs).

7. The method of claim 1, wherein the available frequency channel list include one or more available Absolute Radio Frequency Channel Numbers (ARFCNs).

8. The method of claim 1, wherein the performing the power scan includes performing a comparison between a received signal strength indication (RSSI) and a RSSI threshold.

9. The method of claim 8, further comprising including a frequency channel in the available frequency channel list if the RSSI of the frequency channel is equal to or exceeds the RSSI threshold.

10. The method of claim 1, further comprising performing control channel decoding for each of the frequency channels in the reduced list.

11. The method of claim 10, wherein the control channel decoding includes frequency correction channel (FCCH) decoding and synchronization channel (SCH) decoding.

12. A user equipment for network searching, comprising:
a communications interface for communicating with a wireless network;
a processing circuit coupled to the communications interface for collecting one or more System Information (SI) for a plurality of cells associated with the wireless network;
a memory unit coupled to the communications interface for storing the one or more SI; and
a radio resource module coupled to the communications interface for performing the following:
generating a serving network frequency channel list based on the one or more stored SI;
performing a power scan for one or more supported radio bands for one or more cells within the wireless network;
obtaining an available frequency channel list from the power scan;
comparing the available frequency channel list with the serving network frequency channel list if a Full Service Flag (FSF) has been set; and
removing one or more frequency channels from the serving network frequency channel list to generate a reduced list.

13. The apparatus of claim 12, wherein the radio resource module is housed within the processing circuit.

14. The apparatus of claim 13, further comprising a bus interface for coupling the communications interface, processing circuit and the memory unit.

15. The apparatus of claim 12, further comprising a Layer 1 entity and wherein the radio resource module sends the reduced list to the Layer 1 entity for performing a control channel decoding.

16. The apparatus of claim 12, wherein the radio resource restores the one or more frequency channels removed to recover the serving network frequency channel list.

17. The apparatus of claim 12, wherein the System Information (SI) includes one or more of the following: a cell channel, a neighbor cell information, a control channel information, a cell ID, a location area information, or a cell selection parameters.

18. The apparatus of claim 12, wherein the serving network frequency channel list includes one or more Absolute Radio Frequency Channel Numbers (ARFCNs).

19. The apparatus of claim 12, wherein the available frequency channel list include one or more available Absolute Radio Frequency Channel Numbers (ARFCNs).

20. The apparatus of claim 12, wherein the radio resource module performs the power scan by performing a comparison between a received signal strength indication (RSSI) and a RSSI threshold.

21. The apparatus of claim 20, wherein the radio resource module includes a frequency channel in the available frequency channel list if the RSSI of the frequency channel is equal to or exceeds the RSSI threshold.

22. The apparatus of claim 12, wherein in the Layer 1 entity performs control channel decoding for each of the frequency channels in the reduced list.

23. The apparatus of claim 22, wherein the control channel decoding includes frequency correction channel (FCCH) decoding and synchronization channel (SCH) decoding.

24. An apparatus for network searching, comprising:
means for collecting one or more System Information (SI) for a plurality of cells associated with a wireless network;
means for storing the one or more SI in a memory unit;
means for generating a serving network frequency channel list based on the one or more stored SI;
means for performing a power scan for one or more supported radio bands for one or more cells within the wireless network;
means for obtaining an available frequency channel list from the power scan;
means for comparing the available frequency channel list with the serving network frequency channel list if a Full Service Flag (FSF) has been set; and
means for removing one or more frequency channels from the serving network frequency channel list to generate a reduced list.

25. The apparatus of claim 24, further comprising means for sending the reduced list to an entity prior to the entity performing a control channel decoding.

26. The apparatus of claim 24, further comprising means for restoring the one or more frequency channels removed to recover the serving network frequency channel list.

27. The apparatus of claim 24, wherein the System Information (SI) includes one or more of the following: a cell channel, a neighbor cell information, a control channel information, a cell ID, a location area information, or a cell selection parameters.

28. The apparatus of claim 24, wherein the serving network frequency channel list includes one or more Absolute Radio Frequency Channel Numbers (ARFCNs) and wherein the available frequency channel list include one or more available Absolute Radio Frequency Channel Numbers (ARFCNs).

29. The apparatus of claim 24, further comprising:
means for performing a comparison between a received signal strength indication (RSSI) and a RSSI threshold;
means for including a frequency channel in the available frequency channel list if the RSSI of the frequency channel is equal to or exceeds the RSSI threshold; and
means for performing control channel decoding for each of the frequency channels in the reduced list.

30. A computer-readable storage medium storing computer executable code, operable on a device comprising at least one processor; a memory unit for storing one or more System information (SI), the memory unit coupled to the at least one processor; and the computer executable code comprising:
instructions for causing the at least one processor to collect the one or more System Information (SI) for a plurality of cells associated with a wireless network;
instructions for causing the at least one processor to generate a serving network frequency channel list based on the one or more System Information (SI);
instructions for causing the at least one processor to perform a power scan for one or more supported radio bands for one or more cells within the wireless network;
instructions for causing the at least one processor to obtain an available frequency channel list from the power scan;
instructions for causing the at least one processor to compare the available frequency channel list with the serving network frequency channel list if a Full Service Flag (FSF) has been set; and
instructions for causing the at least one processor to remove one or more frequency channels from the serving network frequency channel list to generate a reduced list.
